(19) United States
(12) Patent Application Publication
(10) Pub. No.: US 2005/0143165 A1
(43) Pub. Date: Jun. 30, 2005

(54) System and method for presenting payouts in gaming systems

(76) Inventors: Bradley Berman, Minnetonka, MN (US); Adam Martin, St. Louis Park, MN (US)

Correspondence Address: CRAWFORD MAUNU PLLC, 1270 NORTHLAND DRIVE, SUITE 390, ST. PAUL, MN, 55120, US

(21) Appl. No.: 10/984,012

(22) Filed: Nov. 8, 2004

Related U.S. Application Data
(60) Provisional application No. 60/518,373, filed on Nov. 8, 2003.

(51) Int. Cl. A63F 13/00

(52) U.S. Cl. 463/20; 463/25

(57) ABSTRACT

A system, apparatus, and method for presenting payouts in primary and/or secondary (bonus) gaming activities. Multiple payout presentation areas are-provided to present symbols affecting an ultimate payout award, where at least some or all of the areas are provided with dynamic values potentially contributing to the ultimate payout award. At least one location designator cooperates in the generation of the payout award by moving from one presentation area to another, and along the way activating the corresponding presentation area for inclusion in the ultimate payout award and/or identifying play parameters representing functions impacting the play of the game.

### RELATED APPLICATIONS

This application claims the benefit of Provisional Patent Application Ser. No. 60/518,373, filed on Nov. 8, 2003, to which priority is claimed pursuant to 35 U.S.C. §119(e) and which is hereby incorporated herein by reference in its entirety.

### FIELD OF THE INVENTION

This invention relates in general to gaming, and more particularly to a system and method for presenting payouts in gaming systems.

### BACKGROUND OF THE INVENTION

Gaming devices such as slot machines have been in use in the U.S. for over a century. The earliest slot machines originally paid out in cigars and chewing gum. Remnants of the early slot machines are manifested in the traditional “fruit” symbols such as cherries, lemons, oranges, etc., which represent the original flavors of gum. Notwithstanding the similarity of the symbols and reels associated with the slot machines of both today and yesteryear, modern day slot machine implementations are markedly different than their mechanical ancestors. This dramatic implementation disparity results primarily from the advent of computers and video capabilities.

Pure chance gaming devices such as slot machines have proved wildly popular, and in recent years have rivaled and even surpassed their once untouchable table game counterparts. One reason for this popularity is the increase in innovation, and the recognition of the need for human stimulation. While true that a primary motivator for people to play gaming devices is the chance to win monetary or other prizes (in the case of legalized gambling), the intrigue and excitement of playing these newly created machines lures people as well. It is therefore important in the gaming industry that gaming innovations be rolled out to the participating public.

Conventionally, participation in slot machines involves initiating the rotation of multiple reels, and allowing the machine to randomly stop the reel rotation such that associated reel symbols line up a payline. If the symbols on that payline correspond to a predetermined symbol combination, the participant wins an amount corresponding to the particular symbol combination. For multi-lined paylines, a coin or other token may be played for any one or more of the available paylines, and each of the paylines may provide a winning payout. When this occurs, the slot machine pays out according to the payoff table posted on the slot machine. The payoff table informs players of the winning symbol combinations for that machine, and what each combination pays based on the number of coins allocated for the spin. If a winning combination occurs, the machine releases money or tokens into a payout chute, or may award the winning amount onto a credit meter for the player. For example, if a player initially wagered three coins and that player won a high payout, that player may receive fifty coins of the same denomination in return, or may receive fifty credits for continued play.

It is a continual effort in the gaming industry to develop ways to attract and captivate players in playing gaming machines, such as slot games. One such manner of stimulating interest and heightening excitement has been through the use of “bonus” events. Bonus events or games are used to attract and keep players at a gaming machine. A bonus game is typically an additional gaming reel or machine, or a random selection device, that is enabled by a bonus qualifying signal from an underlying or primary gaming machine. Generally, a predetermined prize-winning combination of symbols in an underlying or primary game may result in the player being awarded one or more bonus games. Often the bonus event has a much higher probability of winning, thereby instilling a great interest by players in being awarded bonus events.

There are various secondary or “bonus” events known in the art. One such bonus event allows the player to depress a bonus spin button to allow the player one or more additional free spins in which a winning payout may be made. Alternatively, additional, discrete bonus reels may be used for the bonus event. In such case, a particular symbol on any one or more of the reels, which are stopped on a winning line, may result in a winning payout. In some bonus activities, the reels may be controllable in a bonus play, unlike the underlying primary gaming play. For example, the reels may be individually stopped, and/or the reels may be rotated slower to allow the player to attempt to stop the reel such that the prize-winning symbol stops on the win line. In another example, a bonus event for a video slot machine may have a second screen where the player is rewarded with a bonus game, such as allowing the player to pick one of five different items on the second screen, and the selected item reveals a value won by the player. In recent times, bonus events have become quite extravagant, sometimes leading the player through video animations that provide visual and audio entertainment while providing clever ways in which the participant can receive payouts of varying quantities. After engaging in the bonus event, play resumes in the underlying, primary gaming machine.

In furtherance of the need to attract casino patrons, there is a continuing need to further the excitement and visual stimulation in the participation of gaming activities. The present invention fulfills these and other needs, and offers advantages over prior art gaming approaches.

### SUMMARY OF THE INVENTION

To overcome limitations in the prior art described above, and to overcome other limitations that will become apparent upon reading and understanding the present specification, the present invention discloses a system, apparatus, and method for determining gaming payouts in connection with a gaming activity. The present invention allows for multiple payout presentation areas provided to present symbols or other indicia affecting an ultimate payout award, where at least some or all of the areas are provided with dynamic values potentially contributing to the ultimate payout award. At least one location designator cooperates in the generation of the payout award by moving or otherwise repositioning from one presentation area to another, and along the way activating the corresponding presentation area for inclusion in the ultimate payout award and/or identifying play parameters representing functions impacting the play of the game.

Embodiments of methods for presenting gaming payouts for a gaming activity in accordance with the present invention involve rotating a plurality of reels, wherein each of the plurality of reels includes one or more value symbols each representative of a payout value. At least one location activator is moved proximate at least one of the reels, to activate one of the reels for inclusion in a payout award. The payout values on the activated reels, based on the value symbols presented on the activated reels when rotation of the reels has ceased, are awarded to the game player by adjusting the payout award.

Embodiments of the present invention may further involve repeating movement of the location activator and spinning of the reels until one or more play parameters indicate termination of the gaming activity. Play parameters may include termination symbols provided on the reels, wherein movement of the location activator repeats until one or more termination symbols are presented in any of the activated reels, a predetermined number of the activated reels, or after a predetermined number of repetitions. The gaming activity may be presented as a primary gaming activity or as a bonus activity. Participation in embodiments of the present invention as a bonus gaming activity may be enabled upon at least one predetermined event occurring in connection with participation in a primary gaming activity.

The plurality of reels may include play parameter symbols, such as a termination symbol and a respin symbol. The location activator may be placed proximate at least one of the reels by visually advancing the location activator from reel to reel, such as by using a lightway, by highlighting the location, or using any perceivable identifying mechanism.

Embodiments of the present invention are directed to a gaming system including rotatable reels, each reel including one or more value symbols representative of a payout value. At least one location activator is provided in or on the gaming system. A processor of the gaming system is configured to move the location activator to be associated with at least one rotatable reel, and to identify the payout values on the reel associated with the location activator based on the value symbols presented on the associated reel when rotation of the reel has ceased. The processor may be further configured to highlight the rotatable reel using a lightway as the location activator. The gaming system may include a random number generator configured to randomly select the symbols for presentation in the display grid.

The gaming system may be configured to operate via a standard mode of play and/or a bonus mode of play. The gaming system may be configured in its standard mode of play as a slot machine, a video poker machine, a video keno machine, or other gaming machine.

According to another embodiment, a gaming system is provided which includes a display to present a plurality of visually rotating reels. Each of the visually rotating reels is associated with one or more value symbols each representative of a payout value. At least one location activator is provided. A processor is configured to move.(e.g., reposition) the location activator(s) to be progressively associated with each of a plurality of the visually rotating reels, and to identify the payout values on the visually rotating reels associated with the at least one location activator based on the value symbols presented on the associated visually rotating reels when rotation of the visually rotating reels has ceased.

In more particular embodiments of such an embodiment, location activator(s) may be provided using physical/mechanical elements positioned proximate the display to highlight the relevant rotating reels. For example, a light grid may be positioned proximate the display unit. In another embodiment, the display itself may present the location activators. For example, the processor may be configured to direct the display to present the location activator(s) proximate particular ones of the visually rotating reels. In another embodiment, the display may present the location activator(s) as a visual border of the visually rotating reel to which the respective at least one location activator is currently associated. The display may be further configured to present the value symbols on a cylindrical face of at least some of the visually rotating reels where the reels are substantially cylindrical in shape (i.e. cylindrical can also include pentagon, hexagon, octagon, or other shape which is substantially cylindrical in the manner in which it is rotated).

In other embodiments, the display is further configured to present at least some of the value symbols on side faces of rotatable shapes representing corresponding ones of the visually rotating reels, where the side faces are viewable substantially parallel to an axis of rotation of the rotatable shapes. In other embodiments, the display is configured to present at least some of the value symbols on faces of rotatable shapes representing corresponding ones of the visually rotating reels, wherein the “faces” are viewable substantially perpendicular to an axis of rotation of the rotatable shapes.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 generally illustrates one embodiment of the invention where a plurality of rotating reels, together with at least one location activator, collectively identify the dynamic variables used in determining the ultimate payout award;

FIG. 2 illustrates a more particular embodiment of the invention, wherein a 4×4 grid of reels and multiple location activators are utilized;

FIG. 3 is a flow diagram illustrating one embodiment of a method for presenting gaming payouts for a gaming activity in accordance with the present invention;

FIGS. 4A-4J illustrates an example of a sequence of events that may occur during play of the game in accordance with one embodiment of the invention;

FIG. 5 is an embodiment of a casino-style gaming device in which the principles of the present invention may be applied as a bonus activity;

FIG. 6 illustrates another embodiment of the invention, and illustrates other representative variations in accordance with the invention; and

FIG. 7 illustrates a representative computing system capable of carrying out operations in accordance with the invention is illustrated.

### DETAILED DESCRIPTION OF EMBODIMENTS OF THE INVENTION

This document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a manner for presenting payouts in gaming activities. The invention may be used in connection with primary gaming activity and/or in connection with secondary/bonus activity. The invention provides a multi-faceted gaming activity involving multiple activities cooperatively producing a gaming result. In accordance with one embodiment of the invention, multiple payout presentation areas are provided to present indicia affecting an ultimate payout award, where at least some or all of the areas are provided with a dynamic values potentially contributing to the ultimate payout award. For example, the dynamic values may be provided by a rotating reel, rotating wheel, etc. A location designation activity cooperates in the generation of the payout award by moving from one presentation area to another, and along the way activating the corresponding presentation area for inclusion in the ultimate payout award (e.g., credit/monetary award, prizes, etc.) and/or identifying play parameters representing functions impacting the play of the game (e.g., respin, stop, etc.).

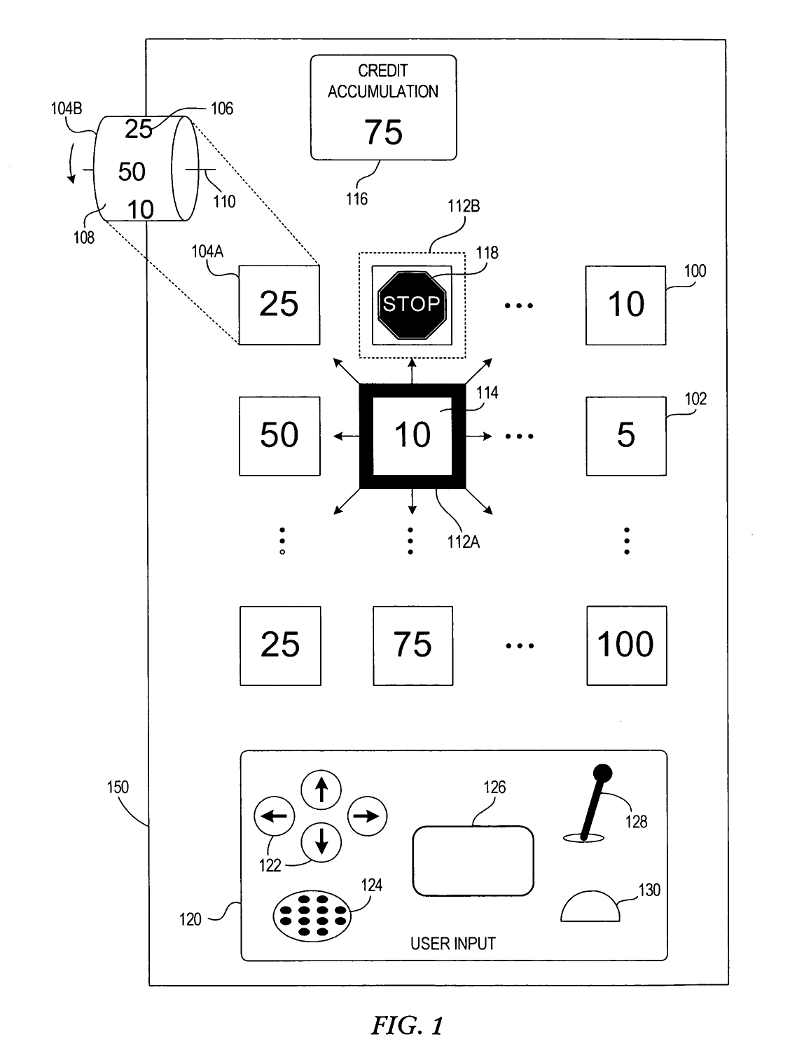

FIG. 1 generally illustrates one embodiment of the invention involving a gaming system 150 where a plurality of rotating reels, together with at least one location activator, collectively identify the dynamic variables used in determining the ultimate payout award. In the embodiment of FIG. 1, a plurality of rotatable reels are provided, such as reels 100, 102, etc. The reels may be physically positioned in a grid, such as a matrix of rows and columns, or may be positioned in other symmetric, asymmetric or random patterns. In the illustrated embodiment each reel, such as reel 104A, includes a plurality of indicia 106 on a visible face 108 of a shape such as a cylindrical reel 104B. The reels rotate about an axis 110, where such an axis may be horizontal, vertical, or otherwise positioned to allow the indicia 106 to be presented. The indicia 106 represents a potential value or function that may be used in determining the ultimate payout award. The reels may rotate independently of one another in the same or different directions, or some or all may rotate together. Any number of wheels or other rotatable shapes may be used, depending on the particular application/game being played.

One or more location activators/designators 112A are used to identify which one or more reels are currently “active” in the sense that the indicia presented on the corresponding reel(s) will be used in the analysis of the payout reward and/or play parameters. In one embodiment, the location-activator will highlight or otherwise set apart the currently active reel(s) to allow the player to see which reel(s) is active.

A representative operational example in which the invention may be used is now described in connection with FIG. 1. Each of the reels spin for some period of time, and during that time the location activator 112A may move about the reels. The location activator 112A may be a physical structure that is physically moved, or may electrically/electronically provided such as by way of lights, colors, or other manner of highlighting the active reel. The location activator 112A may be controlled to move in any direction, such as vertically, horizontally, diagonally, in a predetermined or random pattern, etc. In one embodiment, the location activator 112A moves from reel to reel one at a time. For example, if the location activator 112A is currently associated with reel 114, it may move to any adjacent reel for a subsequent reel activation.

As the location activator 112A moves from reel to reel, the spinning reels will stop spinning to allow the corresponding active reel to present indicia affecting the outcome. In the illustrated example, when the reels stop spinning and the location activator 112A is positioned proximate reel 114, the player is awarded 10 credits which can be paid to the player or added to a credit accumulation 116. In one embodiment the reels thereafter resume spinning, the location activator 112A moves to another location, and further amounts may be paid or included in the credit accumulation 116. This continues until some terminating event occurs, as described more fully below.

The present invention may use any desired terminating events. In one embodiment, a predetermined or random number of such reel activations may limit further advancement of the location activator 112A. If such a threshold has been reached, no further advancement will be allowed and the particular gaming event thus concludes.

In another embodiment, the indicia on the reels and/or the manner of location activator highlighting may indicate the terminating event. For example, the location activator 112A may be presented in different colors, patterns, etc. Where the location activator 112A is visually presented as a lighted color, one color (e.g., green) may represent continued play, while another lighted color (e.g., red) may represent termination of the gaming event.

In one embodiment, indicia on one or more of the reels include functional play parameters that may include one or more discontinue/termination symbols. For example, reel 118 may present a STOP symbol when the reel 118 stops spinning. If the location activator 112A has moved such that it is associated with reel 118 when the STOP symbol is presented (as depicted by dashed location activator 112B), this may represent termination of the gaming activity. Alternatively, some number of STOP symbols may be required to terminate play, such as the third occurrence of a STOP symbol. In another embodiment, such a termination symbol may only eliminate the corresponding reel from the gaming activity. For example, the STOP symbol on reel 118 may simply disable reel 118 from further activity for that particular gaming activity, where the remaining reels remain available for further involvement. In such an embodiment, it may be desirable to increase the number of termination symbols on each of the reels. Other play parameters may also be presented via the reels, such as a RESPIN or blank indicia which neither favorably nor adversely affects the credit accumulation. Any desired play parameters may be provided via the reels.

In addition to award values and/or functional play parameters, the reels may include other indicia such as mathematical symbols. For example, a multiplier may be provided, such as an “X3” symbol indicating a multiplier by three. This may be used, for example, where multiple location activators 112A are used and the multiplier multiplies the value in the reels selected by the other-location activator(s). The multiplier may also be used to multiply the current credit accumulation 116 for the gaming activity.

In one embodiment, the location activator 112A may identify such a multiplier or other such award-impacting information. For example, the location activator 112A may be presented in different colors, patterns, or the like, where a particular color/pattern represents a multiplier for the value (if any) presented via the reel associated with the location activator 112A.

The movement of the location activator(s) I 12A may be system controlled or player controlled. Where system controlled, a random number generation engine may be used to at least in part determine to which location(s) the location activator(s) will be presented. In another embodiment, the player may control where the location activator(s) will move using a user interface (UI) 120. Such a UI may include, for example, directional buttons 122, microphone and associated logic to recognize and act on voice commands, a touch screen or touch pad 126, joystick 128, mouse or trackball 130, or any other UI mechanism.

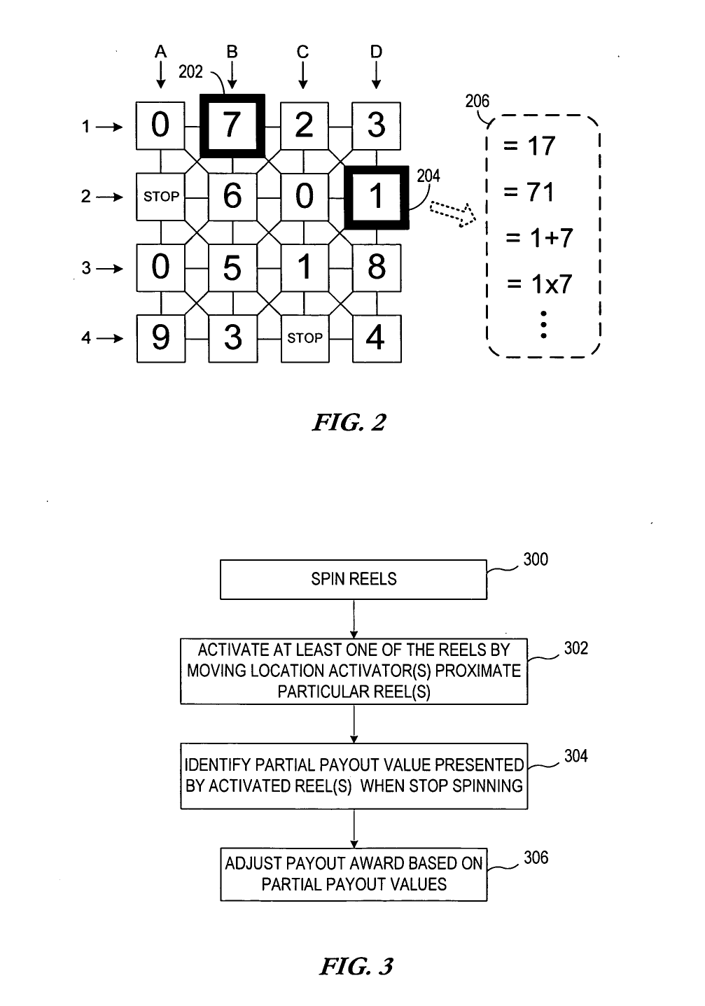

FIG. 2 illustrates a particular embodiment of the invention utilizing a 4×4 grid 200 of reels and multiple location activators. The grid 200 includes columns A, B, C, D and rows 1, 2, 3, 4. For purposes of the description of FIG. 2, particular reels are identified by their column-row association. Each of the reels in the illustrated embodiment include at least some numeric values as well as termination (STOP) symbols. The location activators 202, 204 are depicted as having stopped on locations (B,1) and (D,2). Had either location activator 202, 204 landed on a STOP symbol such as at locations (A,2) and/or (C,4), some termination event would occur. For example, the gaming activity may be terminated if either location activator 202, 204 lands on a STOP symbol, or alternatively only that reel may be suspended from further play in that gaming event. In another embodiment, a random or predetermined number of STOP occurrences may be required before the gaming activity is terminated. For example, using a “three strikes you're out” theme, three STOP (or STRIKE, etc.) symbols may need to occur.

In the illustrated embodiment, the location activator 202 landed on the reel at location (B,1), which presented a value of “7,” while location activator 204 landed on the reel at location (D,2), which presented a value of “1.” Using multiple location activators provides a number of alternative manners 206 of presenting payout amounts. For example, each selected digit may be used to create or “build” a multi-digit value, such as creating a seventy-one (71) credit award when reading the selected values from top/left to right/bottom. Alternatively, the award could be seventeen (17) credits. In another embodiment, the credits awarded are simply the sum (8) of the values of each of the selected/highlighted reels. Or, other mathematical functions may be used with respect to the values, such as multiplication. The color, pattern or other indicator associated with the location activators may be used to indicate such a mathematical function. For example, where the location activators are green, a summing function occurs such that the award in the example of FIG. 2 is eight (8). Where the location activators are blue, a multiplication function occurs such that the award in the example of FIG. 2 is seven (7). Where the location activators flash, a multi-digit value is built using the largest of the two numbers in the “tens place” and the smallest of the two numbers in the “ones place” resulting in an award of seventy-one (71) credits. These examples are merely representative of the many different possible scenarios.

FIG. 3 is a flow diagram illustrating one embodiment of a method for presenting gaming payouts for a gaming-activity in accordance with the present invention. The reels are spun 300, where the reels include value symbols representative of a partial payout value. Additional reels may also be provided that do not include value symbols, such as a reel(s) that includes only play parameter symbols. Such play parameter symbols may also be provided on the reels that include value symbols. A location activator(s) is moved proximate one or more of the reels to activate 302 that reel(s) for inclusion in the payout award. When the reels stop spinning, any value symbols presented on the reel(s) associated with the location activator(s) are identified 304, and the payout award is adjusted 306 accordingly.

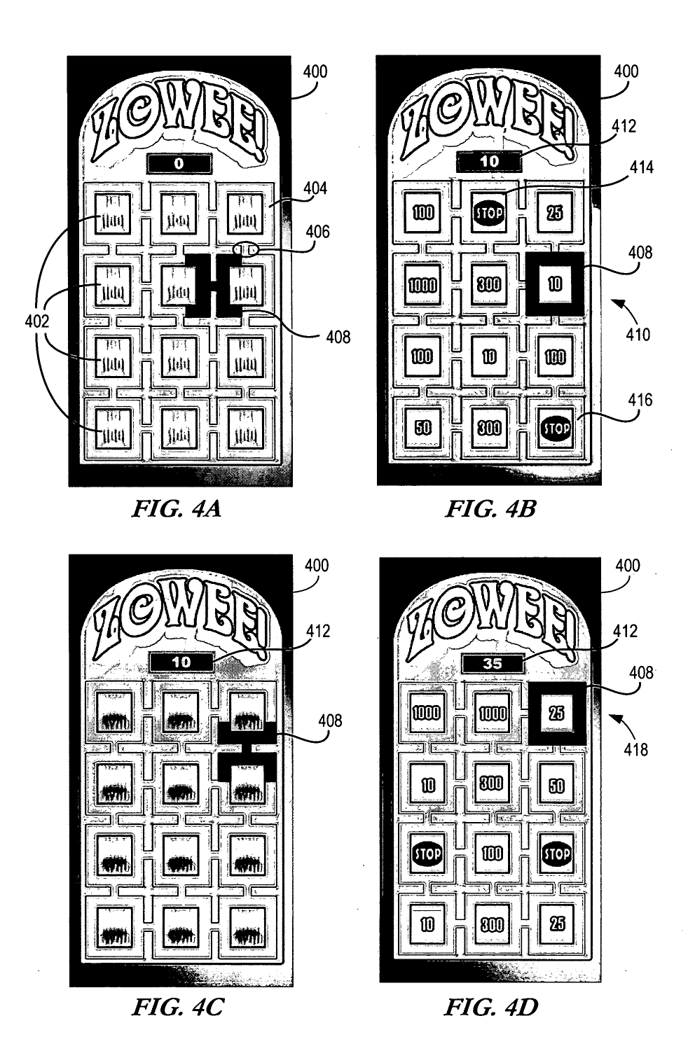

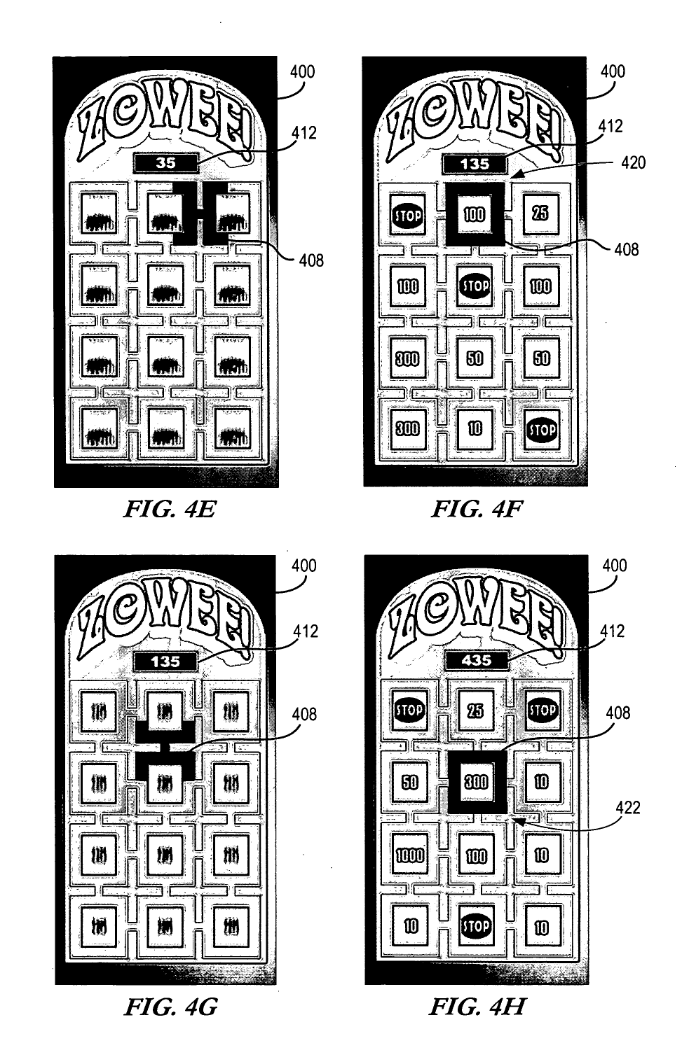

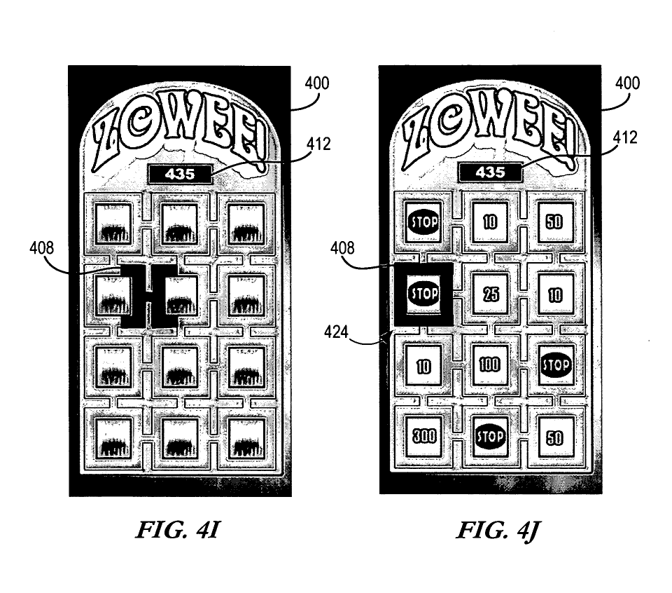

FIGS. 4A-4J illustrates an example of a sequence of events that may occur during play of the game in accordance with one embodiment of the invention. FIGS. 4A-4J use common reference numbers where appropriate to facilitate the description of operation. The operation described in connection with FIGS. 4A-4J may be performed in connection with a primary gaming activity, or alternatively may be provided in connection with a secondary/bonus activity. Further, the gaming activity may be implemented using electronic display and/or mechanical components.

The gaming activity 400 includes a plurality of reels, including reels 402 and other reels. Each of the reels includes various symbols, and is capable of spinning (or in electronic display embodiments, having an appearance of spinning or otherwise disguising the reel presentation temporarily). It is also possible that one or more of the locations associated with a reel(s) does not spin or provide variable indicia, but rather is a static location that always presents the same indicia.

In one embodiment, a lightway or other visual designator is associated with each of the reel locations to provide a visual indication of where the location activator is currently positioned. In the illustrated embodiment, the lightway includes reel surrounding lightways 404 as well as connecting lightway paths 406 between the reel surrounding lightways 404. A lighted or colored area 408 (illustrated as a dark segment for ease of viewing) moves about the reel locations during play of the gaming activity. In one embodiment, the lighted area 408 moves about the reel locations while the reels are spinning, as depicted.

FIG. 4B illustrates the lighted area 408, which corresponds to the location activator, has stopped at reel location 410. In one embodiment, the reels stop spinning when the lighted area 408 reaches a reel location, and as depicted in FIG. 4B the reels have stopped spinning. Thus, the reel at reel location 410 has been “activated” in that it is this reel that will now be considered, while the other reels are not considered at this time. A partial award value is associated with the reel at location 410, which is a value of “10” credits in the illustrated embodiment. This partial award value is now included in a payout accumulation register for the gaming activity, the amount being (optionally) displayed in the payout accumulation display 412.

In some embodiments of the invention, a predetermined or random number of such “movements” may be allowed by the location activator. If that number was predetermined to be one, the gaming activity would then terminate. However, in some embodiments including the illustrated embodiment, one, multiple, or all of the reels may include one or more termination symbols, such as the STOP symbol shown on reels 414, 416. If the lighted area/location activator 410 had stopped at one of these locations 414, 416, the gaming activity may have ended. In another embodiment, multiple termination symbols need to occur before the gaming activity ends. In another embodiment the occurrence of a-termination symbol in an activated reel causes only that reel to be removed from the gaming activity, while the other reels remain available for further activity. For purposes of the embodiment described in FIGS. 4A-4J, it is assumed that the gaming activity ends when the location activator stops on any such termination symbol.

Since the location activator did not stop on a termination symbol, the gaming activity continues. In the illustrated embodiment shown in FIG. 4C, the lighted area 408 moves one reel location at a time (although this is not required). The location activator may move in any direction, and in the illustrated embodiment moves upwards from its previous location 410. When it reaches the next reel location 418 shown in FIG. 4D, the reels again stop spinning, and the award value associated with the reel at location 418 is shown as “25” credits, which is added to the payout accumulation as shown at display 412.

Since the location activator did not stop on a termination symbol, the gaming activity continues. In the illustrated embodiment shown in FIG. 4E, the lighted area 408 moves to the left from its previous location. When it reaches the next reel location 420 shown in FIG. 4F, the reels again stop spinning, and the award value associated with the reel at location 420 is shown as “100” credits, which is added to the payout accumulation as shown at display 412. The credit total is now “135” credits (10+25+100). Since the location activator did not stop on a termination symbol, the gaming activity continues. In the illustrated embodiment shown in FIG. 4G, the lighted area 408 moves downward from its previous location. When it reaches the next reel location 422 shown in FIG. 4H, the reels again stop spinning, and the award value associated with the reel at location 422 is shown as “300” credits, which is added to the payout accumulation as shown at display 412. The credit total is now “435” credits (10+25+100+300). Since the location activator did not stop on a termination symbol, the gaming activity continues. In the illustrated embodiment shown in FIG. 4I, the lighted area 408 moves to the left from its previous location. When it reaches the next reel location 424 shown in FIG. 4J, the reels again stop spinning. This time, the reel at location 424 presented a termination (STOP) symbol, thereby termination the gaming activity. The player is then awarded the accumulated credit total, which remained at “435” credits. In some embodiments, an additional award value may also be associated with a termination symbol. As previously indicated, the present invention may be implemented as a primary gaming activity or a bonus gaming activity. Thus, the player may participate in a primary gaming activity, which may include any desired gaming activity such as slot games, poker games, or other conventional games played on slot machine-style games. For example, the system may be a mechanical or video-slot machine having a plurality of reels, and having one or more paylines. When any of one or more predetermined symbol combinations occurs via the primary gaming activity, the player will be allowed to enter a secondary or “bonus” activity. If the player does not meet the bonus activity criteria (e.g., hit a particular symbol combination in a slot game), the player remains in the standard/primary play mode. Otherwise, the player enters the bonus round, where the player may then participate in the gaming activity of the present invention.

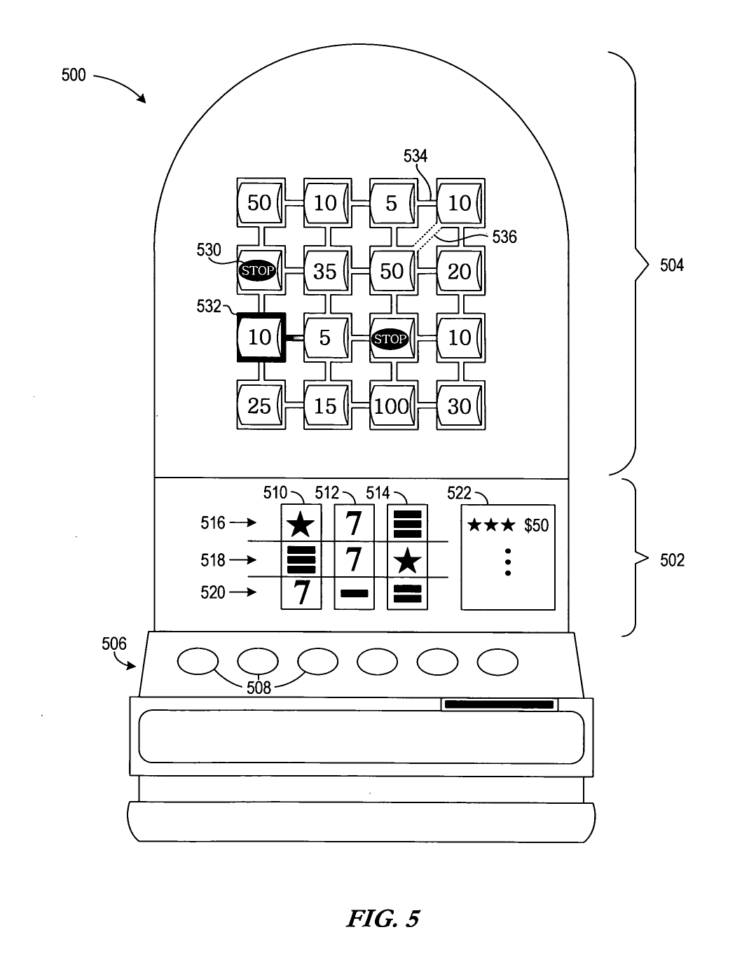

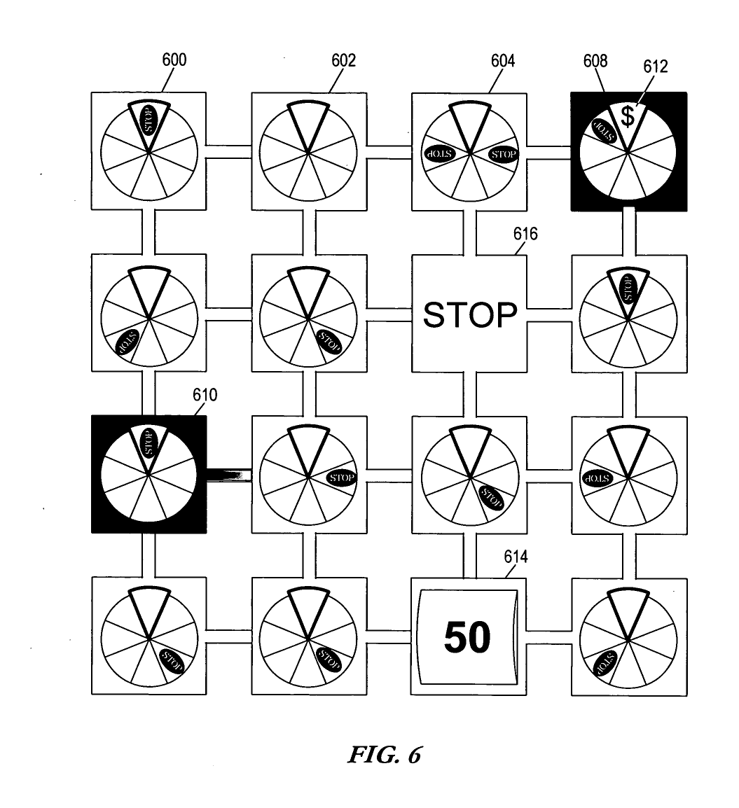

FIG. 5 is an embodiment of a casino-style gaming device in which the principles of the present invention may be applied as such a bonus activity. Many traditional casino table games may be provided in a “video game” available via a casino-style gaming device shown in FIG. 5. For purposes of explanation, the description of the gaming device is FIG. 5 is provided in terms of a slot machine 500. However, the present invention is analogously applicable to other casino-style games (video poker, video bingo, etc.) having the ability to include at least one bonus activity.

The slot machine 500 is a structure including at least a primary gaming activity presentation 502 and a bonus activity presentation 504. The slot machine 500 includes a housing for embodiments having a self-supported, independent structure. A user interface 506 is provided to allow the user to control and engage in play of the slot machine 500. The particular user interface mechanisms associated with user interface 506 is dependent on the type of gaming machine. For example, the user interface 506 may include one or more buttons, switches, joysticks, levers, pull-down handles, trackballs, voice-activated input, or any other user input system or mechanism that allows the user to play the particular gaming activity. The user input 506 allows the user to enter coins or otherwise obtain credits through vouchers, tokens, credit cards, etc. Various mechanisms for entering such vouchers, tokens, credit cards, coins, etc. are known in the art. For example, coin/token input mechanisms, card readers, credit card readers, smart card readers, punch card readers, and other mechanisms may be used to enter wagers. It is through the user input 506 that the user can initiate the standard mode of play, and in some embodiments may optionally control certain aspects of the bonus mode of play, such as controlling the movement of the location activator. In the case of a slot machine, the user input may include a plurality of buttons, e.g., button 508, which allow the user to enter a number of credits to play, identify the number of paylines in which to participate, cash out, automatically bet the maximum amount and paylines, etc. It should be recognized that a wide variety of other user interface options are available for use in connection with the present invention, including pressing a button on a gaming machine, touching a segment of a touch-screen, entering text, entering voice commands, or other known user entry methodology. The particular user interface mechanism employed is not relevant to the present invention.

The primary gaming activity presentation 502 may be provided via a video display device or via mechanical reels. In the case of a video display device, the display device may take on a variety of forms depending on what type of presentation is to be provided. For example, a standard slot gaming activity includes multiple reels 510, 512, 514, and in the illustrated embodiment three paylines 516, 518, 520 are provided. Any number of paylines and/or reels may be provided where the primary gaming activity is a slot game.

Also associated with the gaming device 500 may be a pay table 522, where information associated with the potential winning symbol combinations of the standard slot game activity may be presented. This area may also provide an indication of the requisite symbols, symbol combinations, symbol locations, etc. that are required to invoke the bonus mode in accordance with the invention. This information may be part of a display screen, or alternatively may be separate from the display screen and provided directly on a portion of the structure itself. For example, a backlit colored panel may be used as the winning guide area.

When the player achieves the requisite bonus qualifying criteria via the primary gaming activity, the player will be allowed to participate in the bonus activity in accordance with the present invention. The bonus activity illustrated in FIG. 5 is a multi-reel/wheel gaming device utilizing a mobile location activator as previously described. In the illustrated embodiment, the reels may include numeric values, multipliers, play parameter indicia (e.g. STOP symbol 530), and the like. The location activator 532 may be presented by lighting, highlighting, or otherwise distinguishing the active reel location. This lighting/highlighting feature may be provided between reel locations, as depicted by pathway 534. Pathways may be provided between any of the various reel locations. In the illustrated embodiment, the pathways run horizontally and vertically between reel locations. Optionally, pathways may instead, or additionally, run diagonal as shown by pathway 536, or may be routed in any other desired manner. In one embodiment, as the location activator moves from reel location to reel location, the lighted pathway changes such that the location activator visually moves from reel location to reel location.

FIG. 6 illustrates another embodiment of the invention, and illustrates other representative variations in accordance with the invention. The gaming activity illustrated in FIG. 6 includes a plurality of reel locations, such as reel locations 600, 602, 604, etc. In the illustrated embodiment, the reels are provided as wheels where the indicia are positioned on the side face of the cylindrical wheel shape, or any other rotatable shape. Operation is analogous to that previously described in connection with reels, where the wheels spin, the location activator moves about the grid, and active wheel locations are designated by the location activators. An indicia designator 606 is provided to indicate which of the wheel symbols is selected at a particular wheel location.

FIG. 6 also illustrates other variations. For example, multiple location activators 608, 610 are provided, such that partial award amounts can be determined at multiple reel/wheel locations. For example, the location activator 608 activates the associated reel/wheel location, such that any symbol at the indicia designator associated with wheel location 608 is a relevant symbol in the gaming activity. In the illustrated embodiment, a value ($) 612 is therefore added to an award accumulation.

Other variations include providing one or more “static” values on the grid. For example, a static award value ($50) is shown at reel/wheel location 614. In this case fifty credits will be awarded whenever the location activator 608, 610 stops at location 614. Play parameters may also be provided in such a static manner, such as the STOP symbol at location 616. In this case, the gaming activity terminates when a location activator 608, 610 stops at location 616. Many other variations are also possible.

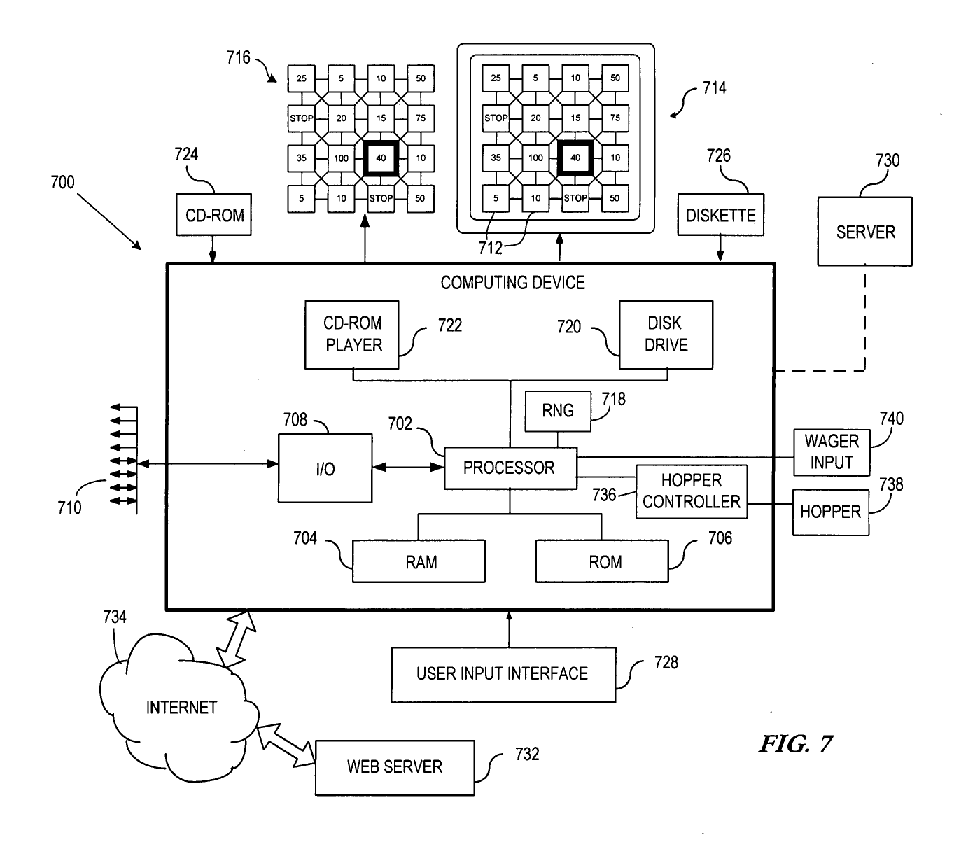

The gaming machines described in connection with the present invention may be independent casino gaming machines, such as slot machines or other special purpose gaming kiosks, video games, or may be computing systems operating under the direction of local gaming software and/or remotely-provided software such as provided by an application service provider (ASP). The casino gaming machines utilize computing systems to control and manage the gaming activity. An example of a representative computing system capable of carrying out operations in accordance with the invention is illustrated in FIG. 7.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 700 of FIG. 7 is an example computing structure that can be used in connection with the primary gaming activity and/or bonus gaming activity for such electronic gaming machines.

The example computing arrangement 700 suitable for performing the gaming activity in accordance with the present invention may include a central processor (CPU) 702 coupled to random access memory (RAM) 704 and some variation of read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing-710, to provide control signals, communication signals, and the like.

Chance-based gaming systems such as slot machines, in which the present invention is applicable, are generally governed by random numbers and processors. Control of electronic reels/wheels 712 on a display 714, and/or control of mechanical reels/wheels 716 in accordance with the invention are provided in part by a random number generator (RNG). RNGs are well known in the art, and may be implemented using hardware, software operable in connection with the processor 702, or some combination of hardware and software. In accordance with generally known technology in the field of slot machines, the processor 702 associated with the slot machine, under appropriate program instruction, can simulate the rotation of the plurality of reels/wheels, and determine the reel/wheel indicia to be presented as well as the location movement of the location activators. The present invention is operable using any known RNG, and may be integrally programmed as part of the processor 702 operation, or alternatively may be a separate RNG controller 718. RNGs are well known in the art, and any type of RNG may be implemented for the standard mode of play and/or the bonus mode of play in accordance with the invention.

The computing arrangement 700 may also include one or more data storage devices, including hard and floppy disk drives 720, CD-ROM drives 722, and other hardware capable of reading and/or storing information such as DVD, etc. In one embodiment, software for carrying out the standard and/or bonus gaming operations in accordance with the present invention may be stored and distributed on a CD-ROM 724, diskette 726 or other form of media capable of portably storing information. These storage media may be inserted into, and read by, devices such as the CD-ROM drive 722, the disk drive 720, etc. The software may also be transmitted to the computing arrangement 700 via data signals, such as being downloaded electronically via a network, such as the Internet. Further, as previously described, the software for carrying out the functions associated with the present invention may alternatively be stored in internal memory/storage of the computing device 700, such as in the ROM 706. The computing arrangement 700 may be coupled to a display 714, which represents a display on which the gaming activities in accordance with the invention may be presented. The display 714 may represent the “presentation” of the video information in accordance with the invention, and may be any type of known display or presentation screen, such as LCD displays, plasma display, cathode ray tubes (CRT), etc. Where the computing device 700 represents a stand-alone or networked computer, the display 720 may represent a standard computer terminal or display capable of displaying multiple windows, frames, etc. A user input interface 728 such as a mouse or keyboard may be provided where the computing device 700 is associated with a standard computer. An-embodiment of a user input interface 728 is illustrated in FIG. 1 as UI 120. User input interface devices may include buttons, joysticks, keyboard, mouse, microphone, touch pad, touch screen, voice-recognition system, etc.

The computing arrangement 700 may be connected to other computing devices or gaming machines, such as via a network. The computing arrangement 700 may be connected to a network server 730 in an intranet or local network configuration. The computer may further be part of a larger network configuration as in a global area network (GAN) such as the Internet. In such a case, the computer accesses one or more web servers 832 via the Internet 734.

Other components directed to slot machine implementations include manners of gaming participant payment, and gaming machine payout. For example, a slot machine including the computing arrangement 700 may also include a hopper controller 736 to determine the amount of payout to be provided to the participant. The hopper controller may be integrally implemented with the processor 702, or alternatively as a separate hopper controller 736. A hopper 738 may also be provided in slot machine embodiments, where the hopper serves as the mechanism holding the coins/tokens of the machine. The wager input module 740 represents any mechanism for accepting coins, tokens, coupons, bills, credit cards, smart cards, electronic funds transfer, tickets (ticket-in-ticket-out; TITO), membership cards, etc. for which a participant inputs a wager amount.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

1. A method for presenting gaming payouts for a gaming activity, comprising:
(a) rotating a plurality of reels, wherein each of the plurality of reels includes one or more value symbols each representative of a payout value;
(b) moving at least one location activator proximate at least one of the reels, to activate the at least one of the reels for inclusion in a payout award;
(c) identifying the payout values on the activated reels based on the value symbols presented on the activated reels when rotation of the reels has ceased; and
(d) adjusting the payout award based on the payout values.

2. The method as in claim 1, further comprising repeating (a)-(d) until one or more play parameters indicate termination of the gaming activity.

3. The method as in claim 2, wherein the play parameters comprise termination symbols, and wherein repeating (a)-(d) until one or more play parameters indicate termination of the gaming activity comprises repeating (a)-(d) until a termination symbol is presented in any of the activated reels.

4. The method as in claim 2, wherein the play parameters comprise termination symbols, and wherein repeating (a)-(d) until one or more play parameters indicate termination of the gaming activity comprises repeating (a)-(d) until termination symbols are presented in a predetermined number of the activated reels.

5. The method as in claim 2, wherein the play parameters comprise termination symbols, and wherein repeating (a)-(d) until one or more play parameters indicate termination of the gaming activity comprises repeating (a)-(d) for each of the reels that, when activated, has not presented a termination symbol.

6. The method as in claim 1, wherein the gaming activity comprises a primary gaming activity.

7. The method as in claim 1, wherein the gaming activity comprises a bonus gaming activity.

8. The method as in claim 7, further comprising enabling participation in the bonus gaming activity upon at least one predetermined event occurring in connection with participation in a primary gaming activity.

9. The method as in claim 1, wherein at least some of the plurality of reels further includes play parameter symbols.

10. The method as in claim 9, wherein the play parameter symbols include any one or more of a termination symbol and a respin symbol.

11. The method as in claim 1, wherein moving at least one location activator proximate at least one of the reels comprises visually advancing the location activator from reel to reel.

12. The method as in claim 1, wherein moving at least one location activator proximate at least one of the reels comprises visually advancing the location activator from reel to reel using a lightway.

13. The method as in claim 1, further comprising highlighting the at least one of the reels that has been activated by the location activator for inclusion in the payout award to identify the at least one of the reels as activated reels.

14. The method as in claim 13, wherein highlighting the at least one of the reels comprises visually distinguishing the activated reels from inactivated reels that are not identified for inclusion in the payout award.

15. The method as in claim 13, wherein highlighting the at least one of the reels comprises associating a lighted indicator with the activated reels.

16. The method as in claim 13, wherein moving at least one location activator comprises advancing the lighted indicator from a previous activated reel to a newly activated reel.

17. The method as in claim 1, wherein the reels comprise wheels, and wherein the value symbols are positioned on faces of the wheels.

18. A gaming system, comprising:
a plurality of rotatable reels each including one or more value symbols each representative of a payout value;
at least one location activator; and
a processor configured to move the at least one location activator to be associated with at least one of the plurality of rotatable reels, and to identify the payout values-on the reels associated with the-at leas~tone-location activator based on the value symbols presented on the associated reels when rotation of the reels has ceased.

19. The gaming system as in claim 18, wherein the processor is further configured to highlight the at least one of the plurality of rotatable reels using a lightway as the at least one location activator.

20. The gaming system as in claim 18, wherein at least some of the plurality of rotatable reels include the one or more value symbols on side faces of the rotatable reels, wherein the side faces are viewable substantially parallel to an axis of rotation of the rotatable reels.

21. The gaming system as in claim 18, wherein at least some of the plurality of rotatable reels include the one or more value symbols on faces of the rotatable reels, wherein the faces are viewable substantially perpendicular to an axis of rotation of the rotatable reels.

22. A casino gaming apparatus hosting a gaming activity having at least a standard mode of operation and a bonus mode of operation, the casino gaming apparatus comprising:
a plurality of rotatable reels each including one or more value symbols each representative of a payout value;
at least one location activator; and
a processor configured to enable participation in the bonus mode of operation upon at least one predetermined event occurring in connection with participation in the primary mode of operation, move the at least one location activator to be associated with at least one of the plurality of rotatable reels, and to identify the payout values on the reels associated with the at least one location activator based on the value symbols presented on the associated reels when rotation of the reels has ceased.

23. The casino gaming apparatus as in claim 22, wherein the processor comprises a random number generator configured to randomly select the symbols for presentation in the display grid.

24. The casino gaming apparatus as in claim 22, wherein the casino gaming apparatus comprises a slot machine, and the standard mode of operation of the slot machine is a slot game.

25. The casino gaming apparatus as in claim 22, wherein the casino gaming apparatus comprises a video poker machine, and the standard mode of operation of the video poker machine is a poker game.

26. The casino gaming apparatus as in claim 22, wherein the casino gaming apparatus comprises a video bingo machine, and the standard mode of operation of the video bingo machine is a bingo game.

27. The casino gaming apparatus as in claim 22, wherein the casino gaming apparatus is a video keno machine, and the standard mode of operation of the video keno machine is a keno game.

28. A computer-readable medium having computer-executable instructions for executing a moving location indicator in a slot game, the computer-executable instructions performing steps comprising:
(a) rotating a plurality of reels, wherein each of the plurality of reels includes one or more value symbols each representative of a payout value;
(b) moving at least one location activator proximate at least one of the reels, to activate the at least one of the reels for inclusion in a payout award;
(c) identifying the payout values on the activated reels based on the value symbols presented on the activated reels when rotation of the reels has ceased; and
(d) adjusting the payout award based on the payout values.

29. A slot machine comprising:
means for rotating a plurality of reels, wherein each of the plurality of reels includes one or more value symbols each representative of a payout value;
means for moving at least one location activator proximate at least one of the reels, to activate the at least one of the reels for inclusion in a payout award;
means for identifying the payout values on the activated reels based on the value symbols presented on the activated reels when rotation of the reels has ceased; and
means for adjusting the payout award based on the payout values.

30. The slot machine of claim 29, wherein the location activator moving means comprises a lightway.

31. A gaming system, comprising:
a display to present a plurality of visually rotating reels, wherein each of the visually rotating reels is associated with one or more value symbols each representative of a payout value;
at least one location activator; and
a processor configured to move the at least one location activator to be progressively associated with each of a plurality of the visually rotating reels, and to identify the payout values on the visually rotating reels associated with the at least one location activator based on the value symbols presented on the associated visually rotating reels when rotation of the visually rotating reels has ceased.

32. The gaming system as in claim 31, wherein the display further presents the at least one location activator.

33. The gaming system as in claim 32, wherein the processor is further configured to direct the display to present the at least one location activator proximate particular ones of the visually rotating reels.

34. The gaming system as in claim 32, wherein the display presents the at least one location activator as a visual border of the visually rotating reel to which the respective at least one location activator is currently associated.

35. The gaming system as in claim 31, wherein the at least one location activator respectively comprises at least one physical element positioned proximate the display to provide the association with each of a plurality of the visually rotating reels.

36. The gaming system as in claim 31, wherein the display is configured to present the one or more value symbols on a cylindrical face of at least some of the plurality of visually rotating reels.

37. The gaming system as in claim 31, wherein the display is configured to present at least some of the one or more value symbols on side faces of rotatable shapes representing corresponding ones of the visually rotating reels, wherein the side faces are viewable substantially parallel to an axis of rotation of the rotatable shapes.

38. The gaming system as in claim 31, wherein the display is configured to present at least some of the one or more value symbols on faces of rotatable shapes representing corresponding ones of the visually rotating reels, wherein the faces are viewable substantially perpendicular to an axis of rotation of the rotatable shapes.
